(19) United States
(12) Patent Application Publication
(10) Pub. No.: US 2009/0263671 A1
(43) Pub. Date: Oct. 22, 2009

(54) Ferroelectric Poly (Vinylidene Fluoride) Film on a Substrate and Method for its Formation

(76) Inventors: Kui Yao, Singapore (SG); Shuting Chen, Singapore (SG); Francis Eng Hock Tay, Singapore (SG)

Correspondence Address: BRACEWELL & GIULIANI LLP, P.O. BOX 61389, HOUSTON, TX, 77208-1389, US

(21) Appl. No.: 12/106,685

(22) Filed: Apr. 21, 2008

(51) Int. Cl. B32B 15/082; B05D 3/02

(52) U.S. Cl. 428/457; 427/374.1

(57) ABSTRACT

Ferroelectric Poly(vinylidene fluoride) Film on a Substrate and Method for its Formation A method of producing a poly(vinylidene fluoride) (“PVDF”) film on a substrate from a precursor solution is disclosed. The method comprises preparing the precursor solution for the PVDF film and dissolving an additive in the precursor solution, the additive being selected from the group consisting of: a hydrate salt, and a hygroscopic chemical. The PVDF is added to the precursor solution. The PVDF solution is coated on a substrate to form an as-deposited PVDF film which is dried and crystallized at an elevated temperature. The dried and crystallized as-deposited PVDF film is annealed at a further elevated temperature. The further elevated temperature is greater than the elevated temperature but less than a melting point of the as-deposited PVDF film. The additive dehydrates at the further elevated temperature. A corresponding product is also disclosed.

### TECHNICAL FIELD

This invention is related to a ferroelectric poly(vinylidene fluoride) (“PVDF”) film on a substrate and a method of forming of such a film on the substrate.

### BACKGROUND

Poly(vinylidene fluoride) and its copolymers are presently important ferroelectric polymer materials, and have obtained commercial applications as piezoelectric, pyroelectric and ferroelectric devices. PVDF is a semi-crystalline polymer, presenting a structure with four possible conformations (α, β, γ, and δ). The α-phase (TGTG′), which is thermodynamically the most stable of the PVDF phases, is not polar. The β-phase has an all-trans (TTT) planar zigzag structure, in which the dipole moments of the two F—C and two C—H bonds add in such a way that the monomer has an effective dipole moment in a direction perpendicular to the carbon backbone. Therefore, the β-phase has the largest spontaneous polarization per unit cell and thus exhibits the highest ferroelectric and piezoelectric properties. The γ and δ-phases are also polar but the dipole moment is significantly smaller.

Therefore, increasing β-phase content is always critical for ferroelectric, piezoelectric or pyroelectric-related applications for PVDF. The conditions under which a specific crystalline conformation can be obtained depend strongly on the processing, and thermal or mechanical treatments, the polymer undergoes.

Poly(vinylidene-fluoride-co-trifluoroethylene) (“P(VDF/TrFE)”), a copolymer of PVDF, can easily crystallize into a 1-phase dominated structure from melt or solution. It is often used to replace PVDF. However, due to its molecular structure P(VDF/TrFE) may contain fewer dipoles but more structural defects than PVDF. P(VDF/TrFE) is also significantly more expensive than PVDF. Moreover, the β-phase PVDF homopolymer has a melting point of 170° C. and does not show

Curie transition until melt. The melting point of P(VDF/TrFE) is normally below 150° C. and the Curie transition point is usually lower than 130° C., both of which depend on the percentage of TrFE monomers in the copolymer. Therefore, compared to P(VDF/TrFE), the PVDF homopolymer is more favorable for applications requiring a broader temperature range. It may cover relatively high temperatures such as those well above 100° C. Thus, PVDF homopolymer is more competitive for many device applications in term of cost and some performance properties.

For the free-standing PVDF homopolymer without a substrate, the β-phase can be conveniently obtained by a mechanical stretching process, which is not applicable for a PVDF thin film deposited on a substrate. Although PVDF films derived from polar solvents, such as dimethylsulphoxide (“DMSO”), dimethylformamide (“DMF”) and dimethylacetamide (“DMAc”), can form polar phase (β or γ phase), the β phase is only stable at low drying temperatures (less than 50° C.). The low drying temperature results in films that are too porous for electric device applications, and that have seriously deteriorated electrical properties.

It has previously been found that a β-phase dominated, dense PVDF thin film can be achieved on a substrate by the addition of Mg(NO₃)₂.6H₂O in the solution. It can be dried at an elevated temperature. This may result in a PVDF thin film on a substrate with ferroelectric properties. However, the obstacles to applications were not solved with such PVDF thin films with the β-phase promoted by Mg(NO₃)₂.6H₂O. The obtained β-phase PVDF thin films contained substantial quantities of water and thus had a large dielectric loss and poor reliability. Moreover, the PVDF thin films were not uniform with poor surface roughness and large particles were dispersed on the surface of the film.

### SUMMARY

According to an exemplary aspect there is provided a method of producing a poly(vinylidene fluoride) (“PVDF”) film on a substrate from a precursor solution. The method comprises preparing solvent and dissolving an additive in solvent to form a solution, the additive being selected from the group consisting of: a hydrate salt, and a hygroscopic chemical. The PVDF is added to the solution to form the precursor solution. The PVDF solution is coated on a substrate to form an as-deposited PVDF film which is dried and crystallized at an elevated temperature. The dried and crystallized as-deposited PVDF film is annealed at a further elevated temperature. The further elevated temperature is greater than the elevated temperature but less than a melting point of the as-deposited PVDF film. The additive dehydrates at the further elevated temperature.

The PVDF film may be a dense ferroelectric β-phase PVDF polymer thin film. The additive may be dissolved in the precursor solution before the PVDF is introduced to the precursor solution. The solvent may be a mixture of dimethylformamide (“DMF”) and acetone.

According to another exemplary aspect there is provided a substrate having coated thereon a dense ferroelectric β-phase PVDF polymer thin film. The dense ferroelectric β-phase PVDF polymer thin film comprises an additive being selected from: a hydrate salt, and a hygroscopic chemical. The dense ferroelectric β-phase PVDF polymer thin film is able to be dried and crystallized at an elevated temperature and annealed at a further elevated temperature. The further elevated temperature is greater than the elevated temperature but less than a melting point of the dense ferroelectric β-phase PVDF polymer thin film. The additive dehydrates at the further elevated temperature.

For both aspects, there may be substantially no dehydration of the additive at the elevated temperature. The dehydration of the additive at the further elevated temperature may comprise the decomposition of the additive. The decomposition of the additive may comprise converting the additive to another chemical. The other chemical no longer may be an hydrate salt or an hygroscopic chemical and may be substantially unable to unite with or absorb water.

The hydrate salt may be at least one of: aluminum nitrate nonahydrate at a concentration in the range 1 to 20% by weight, aluminum chloride hexahydrate at a concentration in the range 8 to 20% by weight, and chromium nitrate nonahydrate at a concentration in the range 4 to 20% by weight. The hygroscopic chemical may be at least one of: ammonium acetate at a concentration in the range 4 to 40% by weight, 4-amino-2-hydroxybenzoic acid at a concentration in the range 8 to 40% by weight, and 1,3-acetonedicarboxylic acid at a concentration in the range 8 to 40% by weight. The weight percentage may be the amount of the additive to the amount of PVDF expressed as a percentage.

A layer of a conductive metal may be coated on the substrate. The as-deposited PVDF film may be coated on the layer of conductive metal. The layer of the conductive metal may comprise a lower electrode. The substrate may be heated prior to the coating to form an oxide layer on the substrate. The layer of the conductive metal may be coated on the oxide layer. A top electrode may be formed on the PVDF film. The elevated temperature may be in the range 60° C. to 110° C. The further elevated temperature may be in the range 110° C. to 170° C.

The substrate may be used in an electronic device consisting of: a piezoelectric sensor, a piezoelectric transducer, a piezoelectric actuator, a ferroelectric Random Access Memory, and a dielectric film for capacitors.

According to a further exemplary aspect there is provided a poly(vinylidene fluoride) film on a substrate when produced by the method described above.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is a graph of thermogravimetric analysis (“TGA”) result for (Al(NO₃)₃.9H₂O) with a ramp rate of 5° C./min.;

FIG. 2 is a graph of the isothermal TGA of Al(NO₃)₃.9H₂O at 135° C.;

FIG. 3 is a series of graphs of the FTIR spectra of an exemplary PVDF thin film with:

(a) with 4 wt. % Mg(NO₃)₂.6H₂O;

(b) with 1 wt. % Al(NO₃)₃.9H₂;

(c) with 2 wt. % Al(NO₃)₃.9H₂O;

(d) with 4 wt. % Al(NO₃)₃.9H₂O;

(e) with 8 wt. % Al(NO₃)₃.9H₂O; and

(f) without a hydrate salt

in the PVDF thin film where the weight percentage is the amount of the additive to the amount of PVDF expressed as a percentage;

FIG. 4 is four graphs of the XRD patterns of exemplary PVDF thin films with various concentrations of Al(NO₃)₃.9H₂O:

(a) 1 wt. %;

(b) 2 wt. %;

(c) 4 wt. %; and

(d) 8 wt. %;

FIG. 5 is a graph of the electric field hysteresis loop of an exemplary PVDF thin film with Al(NO₃)₃.9H₂O added in the solution (at 4 wt. % in the exemplary PVDF thin film);

FIG. 6 is a three-dimensional graph of the instantaneous vibration data of an exemplary PVDF film;

FIG. 7 is a graph of the simultaneous DSC-TGA of Mg(NO₃)₂.6H₂O;

FIG. 8 is a graph of the TGA of an exemplary PVDF film with 4 wt. % Mg(NO₃)₂.6H₂O (solid line) and without the salt (dashed line);

FIG. 9 is a graph of a comparison of the dielectric loss of an exemplary PVDF thin films derived from a solution with Mg(NO₃)₂.6H₂O or Al(NO₃)₃.9H₂O added;

FIG. 10 is two SEM images of the surface of exemplary PVDF thin films with:

(a) Mg(NO₃)₂.6H₂O and

(b) Al(NO₃)₃.9H₂O introduced in the precursor solution;

FIG. 11 is a graph of the TGA of AlCl₃.6H₂O;

FIG. 12 is a graph of the isothermal TGA of AlCl₃.9H₂O at 140° C.;

FIG. 13 is the FTIR spectra of exemplary PVDF thin films derived from the solution:

(a) with 8 wt. % AlCl₃.9H₂O;

(b) with 16 wt. % AlCl₃.9H₂O; and

(c) without hydrate salt.

FIG. 14 is a graph of the polarization vs electric field of an exemplary PVDF thin film when 8 wt. % AlCl₃.6H₂O is used as the additive;

FIG. 15 is a graph of the TGA of ammonium acetate;

FIG. 16 is a schematic, not-to-scale cross sectional view of a substrate with an exemplary PVDF thin film; and

FIG. 17 is a flow chart of an exemplary method.

### DETAILED DESCRIPTION OF THE EXEMPLARY EMBODIMENTS

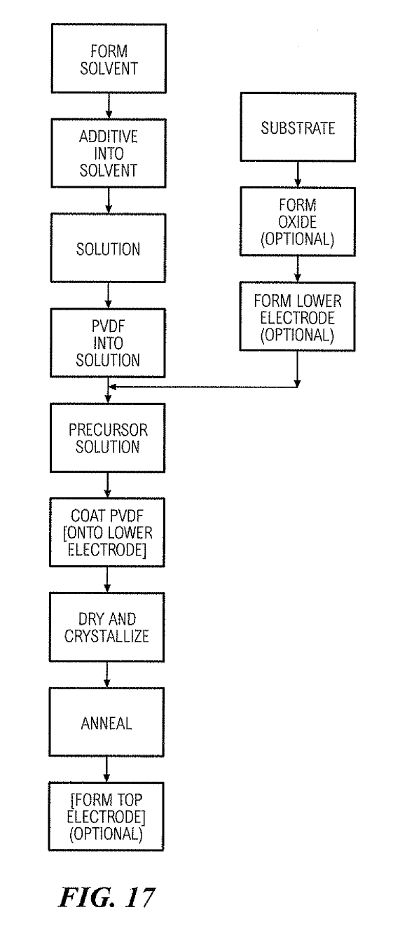

In the exemplary embodiments and with particular reference to FIGS. 16 and 17, dense β-phase ferroelectric PVDF thin films with reduced dielectric losses, and uniform morphology are prepared on a substrate through a solution approach, using application technologies such as, for example, spin-coating and dip coating. At least one additive being a hydrate salt or one hygroscopic chemical is introduced in the precursor solution to promote the β-phase in the resulting PVDF thin films. A hydrate salt is a salt containing water molecules that are either bound to a metal ion centre, or crystallized with the metal complex. As such, the water molecules are crystallized in the crystalline structure of the salt, rather than physically absorbed. An hygroscopic chemical is a chemical that can attract water molecules from the surrounding environment. Most hydrated salts are hygroscopic chemicals, but many hygroscopic chemicals are not hydrated, such as, for example, ammonium acetate. Examples of hydrate salts are: aluminum nitrate nonahydrate, aluminum chloride hexahydrate and chromium nitrate nonahydrate. Examples of hygroscopic chemicals are: ammonium acetate, 4-amino-2-hydroxybenzoic acid, and 1,3-acetonedicarboxylic acid.

The as-coated PVDF thin films are thermal treated in two stages. In one stage, the added hydrate salt or hygroscopic chemical can retain all or some of the contained water during one thermal treatment for drying and crystallizing the films. This will be above at least 50° C. During the first stage there is formation of the β-phase. In the other stage, the added hydrate salt or hygroscopic chemical dehydrates, preferably dehydrates completely, and more preferably decomposes, in a further thermal treatment at a higher temperature than that of the first thermal treatment. The further thermal treatment is at a temperature below the melting point of PVDF, which is around 170° C. Preferably, the other stage is subsequent to the first stage.

Thus, the water is retained in the PVDF thin films during the drying and crystallization process of the first thermal treatment. This will assist the formation of β-phase and a dense morphology. After the crystallization of the β-phase, the water in the PVDF film is removed during the further thermal treatment at a temperature below the melting point of PVDF. There is substantially no water remaining in the β-phase PVDF thin films after the further thermal treatment.

In the first stage thermal treatment of the PVDF thin films, drying and crystallization take place. The preferred temperature is in the range 60 to 110° C., preferably 70 to 110° C. For the further thermal treatment, enhancement of the crystallization takes place as well as the dehydration of the thin films. The film is preferably at a temperature in the range 110 to 170° C., preferably 120 to 155° C. In addition to dehydration, preferably the hydrate salt or hygroscopic chemical decomposes to another chemical. Throughout this specification decomposition is to be taken as including conversion to another chemical. The decomposition is such that the decomposed hydrate salt or hygroscopic chemical is no longer a hydrate salt, and/or no longer an hygroscopic chemical. As such, generally it is not able to substantially unite with or absorb water. The extent of decomposition will depend on the starting additive. For example, ammonium acetate substantially totally decomposes. This will improve the stability of the PVDF thin films.

In performing the method, a solvent for PVDF is prepared at room temperature by mixing DMF and acetone. At least one additive being an hydrate salt or hygroscopic chemical is added in the solution and dissolved completely by an appropriate technique such as, for example, stirring. By way of example only, hydrate aluminum nitrate (Al(NO₃)₃.9H₂O), hydrate aluminum chloride (AlCl₃.6H₂O), and/or hygroscopic ammonium acetate (CH₃COONH₄), may be used as the hydrate salt or hygroscopic chemical. The added hydrate salt or hygroscopic chemical can retain all or a fraction of the contained water above 60° C., but can dehydrate completely, and further decompose to another chemical below the meting point of PVDF. The other chemical should not be an hydrate salt or an hygroscopic chemical. As an example, hydrate aluminum nitrate (Al(NO₃)₃.9H₂O) is selected as the hydrate salt dissolved in the mixed solvent of DMF and acetone.

As the dense β-phase ferroelectric PVDF thin films may be of a thickness of about 1 μm, if the additive is an hygroscopic chemical, it may dehydrate very quickly during the first drying stage, thereby reducing the β-phase formation. As such, the hydrate salts are preferred as the water is part of the crystalline structure and therefore will not evaporate as quickly. This can more effectively promote the formation of the β-phase.

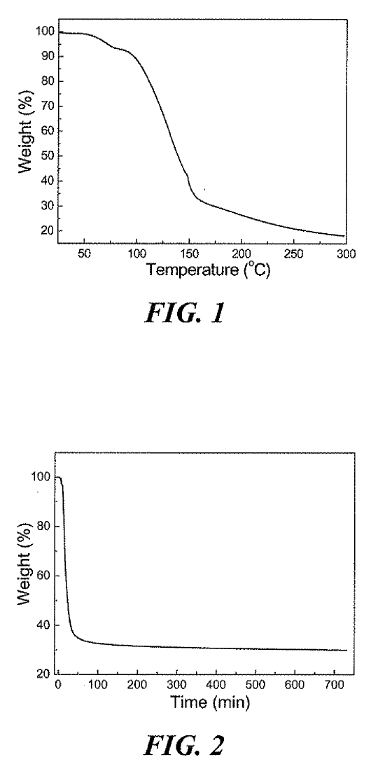

FIG. 1 shows the TGA result for (Al(NO₃)₃.9H₂O) with a ramp rate of 5° C./min, and FIG. 2 shows an isothermal TGA curve at 135° C. The weight loss at a temperature of 135° C. is about 70%. According to the molecular formula, the crystalline hydrate occupies 43.2% by weight. The thermal analysis results indicate that the Al(NO₃)₃.9H₂O starts to decomposes below 170° C., in addition to dehydration.

After the Al(NO₃)₃.9H₂O has been dissolved completely, the PVDF polymer, typically of a phase in the form of powder or pellet, or any other suitable form, is introduced to the solution of DMF and acetone, followed by stirring at 60° C. for 40 minutes, until a clear PVDF solution is obtained as a precursor solution. Different amounts of Al(NO₃)₃.9H₂O may be introduced. The concentration of Al(NO₃)₃.9H₂O is preferably in the range of 1-20% by weight in PVDF.

The precursor solution is then coated on various substrates to form PVDF thin films by spin-coating, dip-coating, or solution casting. The substrate may be, for example, metal, glass, silicon, or any other suitable material. The substrate should be able to withstand the temperatures required for the formation of the PVDF thin film. This means they should be able to withstand temperatures in the range 110 to 170° C., preferably 120 to 155° C., and more preferably 130-145° C. By way of example, the PVDF thin film is prepared on a surface-polished and (100)-orientated single-crystal silicon substrate. The Si substrate may be prior oxidized by being heated at 1000° C. for 90 minutes. This heating process forms a layer of silicon oxide that is about 0.45 μm thick.

A layer of a conductive metal such as, for example, aluminum of a thickness of approximately 0.3 μm may be deposited above the silicon oxide layer by sputtering. The Al layer is subsequently used as an electrode.

The PVDF solution is spin-coated on top of the substrate or Al layer (if provided), and the as-deposited film is subsequently dried on a hot plate with a temperature in the range 60 to 110° C., preferably 80 to 100° C. During the drying process, crystallization of PVDF usually occurs concurrently. Drying and crystallizing the films at 100° C., or a temperature above 60° C., obtains a dense morphology of the PVDF thin film. Drying and crystallization at room temperature normally results in a porous morphology that is not able to be used for ferroelectric thin films. To enhance the crystallization, the film is annealed at a temperature between 110 to 170° C., preferably 120 to 155° C., more preferably 130-145° C. During annealing the hydrate salt Al(NO₃)₃.9H₂O dehydrates completely, and decomposes.

The spin speed affects the thickness of the obtained films. The obtained film thickness is between about 0.9 and 1.1 μm at a spin speed of 1000 rpm for 20 sec.

After the PVDF thin films have been annealed, an electrode of a highly conductive material such as, for example, gold, may be deposited on top of the films. Electrical and piezoelectric properties of the PVDF thin films can be measured with the Au top electrode and the Al bottom electrode on the silicon oxide layer. If there is no Al bottom electrode, there may be two Au top electrodes.

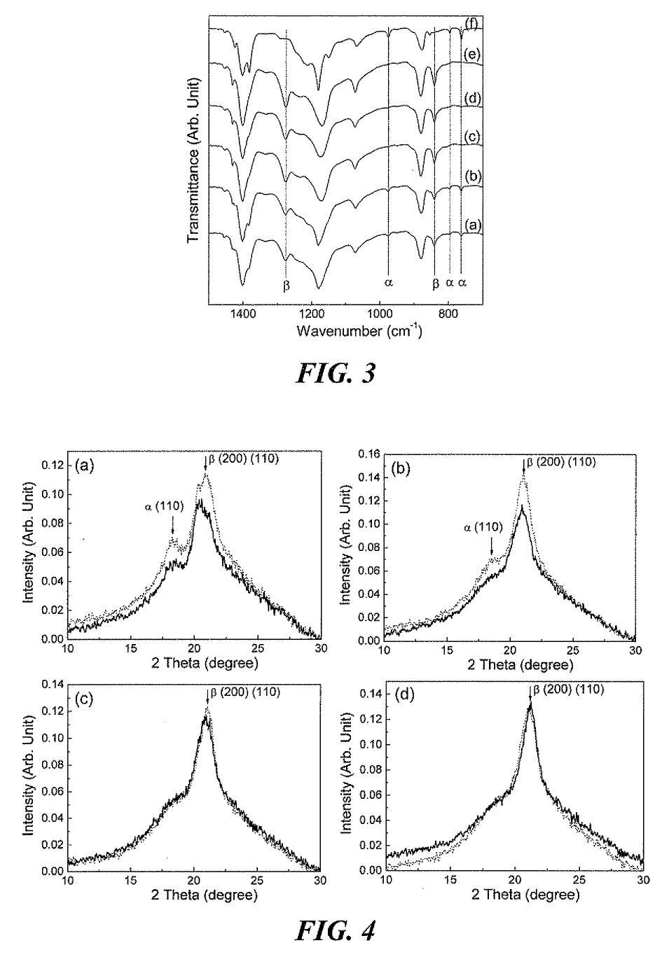

FIG. 3 gives the Fourier transform infrared (“FTIR”) spectroscopic results of the obtained PVDF thin films with Al(NO₃)₃.9H₂O of different concentrations (FIGS. 3(b)-(e)). For comparison, the FTIR spectra of a PVDF thin film prepared using the same method but without any hydrate salt, or with a different hydrate salt Mg(NO₃)₂.6H₂O, are also given in FIGS. 3(f) and (a), respectively. The peaks attributed to the α-phase and the β-phase are marked in FIG. 3. The unmarked peaks are common to both the α-phase and the β-phase. It is noted that the polar ferroelectric β-phase forms with addition of the hydrate salts. Particularly, with the addition of Al(NO₃)₃.9H₂O of more than 2% by weight, the β-phase becomes dominant. The non-polar α-phase becomes almost undetectable. By contrast, only the non-polar α-phase forms in the PVDF thin film without the hydrate salt added in the solution. With Mg(NO₃)₂.6H₂O of 4% by weight added, there is still a substantial amount of the non-polar α-phase in the PVDF film, although the β-phase is dominant. All the films are dried at 100° C.

The XRD patterns of the PVDF thin films with various concentrations of Al(NO₃)₃.9H₂O are shown in FIG. 4. From this it can be determined that the dominant β-phase is formed in the PVDF thin films when Al(NO₃)₃.9H₂O added to the solution. The solid lines represent the XRD patterns of the films dried at 100° C. and the dotted lines represent the XRD patterns of the films after annealed at 135° C.

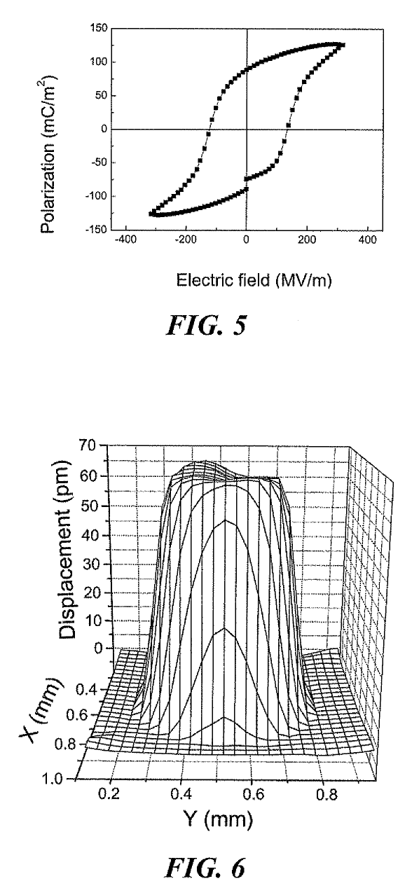

A conductive metal layer, such as gold, can be deposited by sputtering or evaporation on the top of the PVDF thin film as the top electrode. A maximum dielectric constant of about 12 is obtained at 1 kHz in PVDF thin films with Al(NO₃)₃.9H₂O present at about 4% by weight. FIG. 5 presents its polarization-electric field hysteresis loop, with a large remnant polarization of 89 mC/m².

After the PVDF thin film is poled at 200 MV/m at 100° C., the piezoelectric properties can be characterized by measuring the deformation under an electric field. FIG. 6 shows the mechanical vibration created by an exciting sine wave AC voltage. The corresponding longitudinal piezoelectric coefficient d₃₃ is determined to be 13.9 pC/N, without considering the clamping effect of the substrate. With numerical simulation after considering the elastic clamping of the substrate, the actual d₃₃ is estimated to be around 30 pC/N, which is similar to that of the uni-axially stretched, bulk free-standing PVDF membrane. The vibration reaches the maximum during electric sine wave driving of 5 V at 10 kHz. The film was derived from a solution with 4 wt. % of Al(NO₃)₃.9H₂O.

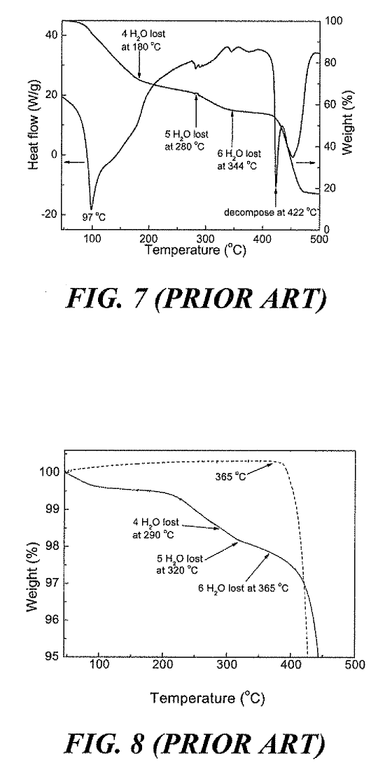

FIG. 7 shows that Mg(NO₃)₂.6H₂O has a very high dehydration temperature (around 340° C.) and decomposition temperature (around 422° C.). The maximum annealing temperature of a PVDF thin film should be lower than the melting point of PVDF, which is around 170° C. This is to avoid the crystallization of the non-polar a phase from the melt. Therefore, when Mg(NO₃)₂.6H₂O is used in the solution, water will remain in the PVDF thin film after annealing. FIG. 8 shows the thermal analysis of a PVDF film with 4 wt. % of Mg(NO₃)₂.6H₂O. It confirms that the water loss takes place only when the PVDF thin film is heated above 170° C. causing the PVDF film to melt, and the loss of the β-phase.

Structure and property characterization results show that the residual Mg(NO₃)₂.xH₂O causes at least two serious problems with resulting PVDF thin films for practical applications:

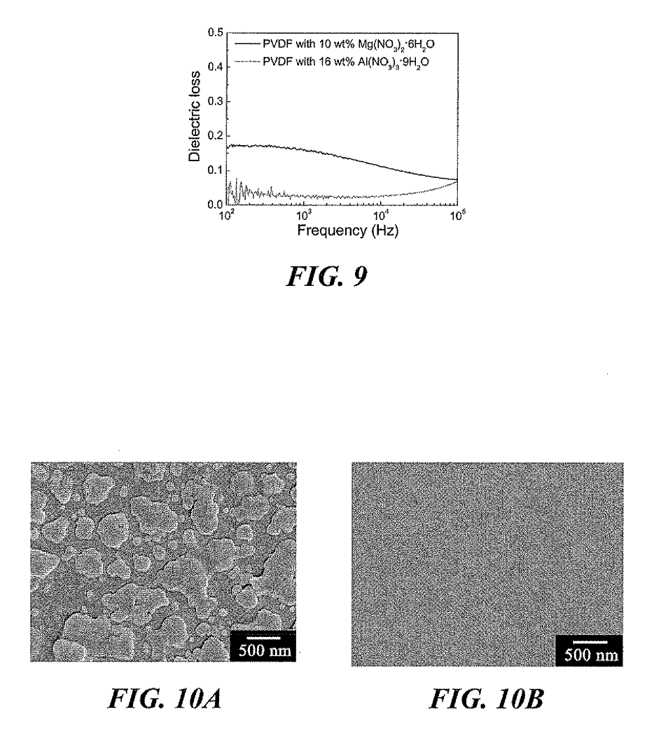

(1) the residual water in the PVDF thin film causes large dielectric loss. The loss increases with an increased concentration of Mg(NO₃)₂.xH₂O. A comparison of the dielectric loss for PVDF thin films with Mg(NO₃)₂.6H₂O or Al(NO₃)₃.9H₂O added in the solution is shown in FIG. 9. The dielectric loss for the PVDF thin film with Mg(NO₃)₂.6H₂O is significantly higher.

(2) The PVDF thin film derived from a solution with added Mg(NO₃)₂.6H₂O has a rough surface and significant in-homogeneity. A comparison in the film surface morphology is shown in FIG. 10. The PVDF thin film of FIG. 10(b) shows a significantly improved surface, and significant homogeneity.

Therefore, by using Al(NO₃).9H₂O instead of Mg(NO₃)₂.6H₂O in the solution these two problems are addressed.

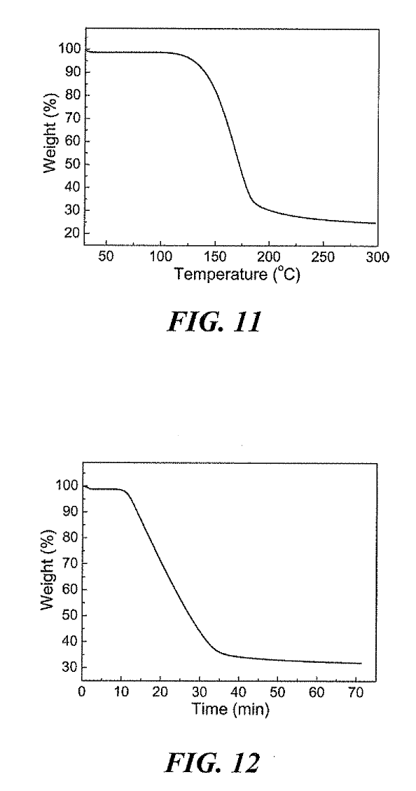

In a second exemplary embodiment, hydrate aluminum chloride (AlCl₃.6H₂O) is added into the precursor solution of a PVDF thin film in place of Al(NO₃)₃.9H₂O. The preparation procedure is similar to that of the PVDF with Al(NO₃)₃.9H₂O as described above. FIG. 11 shows the TGA result when AlCl₃.6H₂O is included in the precursor solution. As the water is approximately 45% of the weight of the additive, the water is all lost below 170° C. The ramp rate used was 5° C./min. FIG. 12 shows an isothermal TGA curve at 140° C. The weight loss at a temperature of 140° C. is about 70%. As the crystalline hydrate only occupies 45% by weight, the thermal analysis results indicate that the AlCl₃.6H₂O starts to decompose and dehydrate below 140° C. The further weight loss indicates that the additive compound further decomposes such that it is no longer an hydrate salt and/or an hygroscopic chemical.

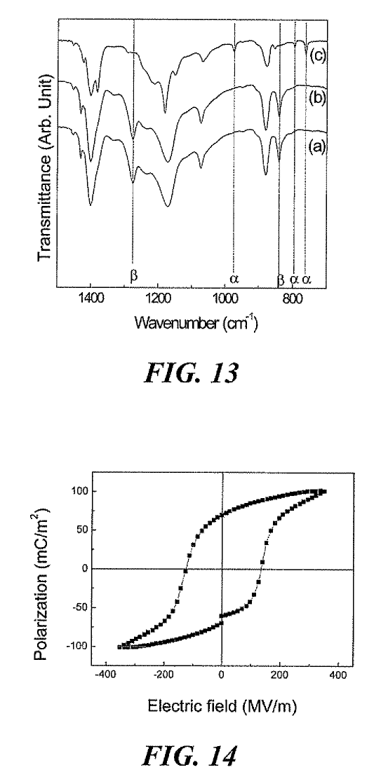

FIG. 13 shows the FTIR spectra of a PVDF thin film with and without AlCl₃.6H₂O added in the precursor solution. The curves indicate that with AlCl₃.6H₂O added to the precursor solution, the β-phase forms instead of the α-phase. The films are dried and crystallized at 100° C. without significant dehydration of AlCl₃.6H₂O. This is followed by final annealing and dehydration. Drying and crystallization at room temperature resulted in a porous morphology that can not be used as a ferroelectric thin film. All the PVDF thin films were dried at 100° C. The unmarked peaks are common to both the α-phase and the β-phase.

In FIG. 14 there is shown the hysteresis loop of polarization versus electric field for the PVDF thin films with 8 wt. % AlCl₃.6H₂O added. A large remnant polarization of about 70 mC/m² is exhibited.

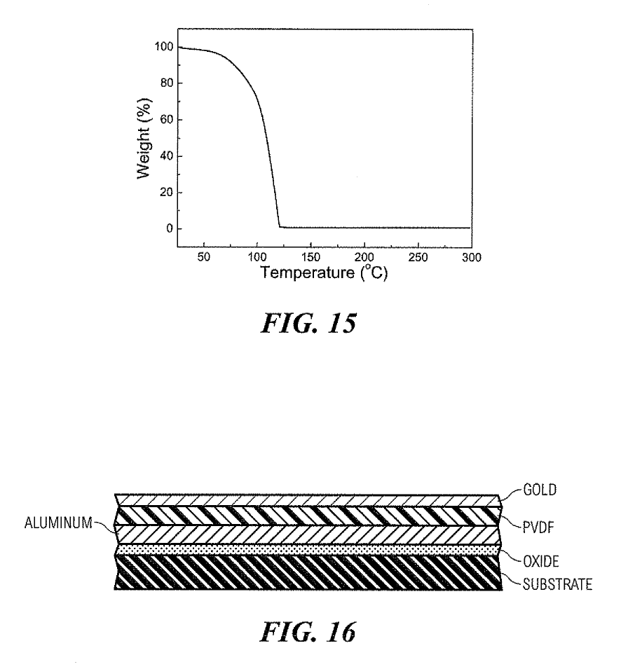

In the third exemplary embodiment, hygroscopic ammonium acetate (CH₃COONH₄) is added into the precursor solution of a PVDF thin film in place of Al(NO₃)₃.9H₂O. The preparation procedure is similar to that of the PVDF film with Al(NO₃)₃.9H₂O added. FIG. 15 shows the TGA result for CH₃COONH₄. The ramp rate used was 5° C./min. The CH₃COONH₄ is able to substantially completely decompose in the range 110 to 120° C.

Similarly, many other hydrate salts or hygroscopic chemicals with a dehydrate temperature and decomposition temperature in the range of 50 to 170° C., preferably 70 to 150° C., more preferably 100 to 110° C., may be used in the PVDF precursor solution. They may also lead to a dense, β-phase, ferroelectric PVDF thin film on a substrate. More preferably, the hydrate salt or hygroscopic chemical can decompose, or be converted to another chemical in the subsequent annealing process below the melting point that is not able to unite with or absorb water. This will further improve the quality and stability of the PVDF thin films.

In the present invention, dense β-phase ferroelectric PVDF homopolymer thin films with low dielectric loss and uniform morphology are obtained for the first time on a substrate for device applications.

The PVDF thin films on a substrate may, for example, be used for piezoelectric sensors, piezoelectric transducers, piezoelectric actuators, ferroelectric Random Access Memories (FRAM), and a dielectric film for capacitors.

Whilst exemplary embodiments have been described with reference to the accompanying drawings, it will be appreciated by a person skilled in the technology concerned that many variations or modifications in details of design, manufacture or method may be made without departing from the invention as defined by the following claims.

1. A method of producing a poly(vinylidene fluoride) (“PVDF”) film on a substrate from a precursor solution, the method comprising:
preparing a solvent for the PVDF film;
dissolving an additive in the solvent to form a solution, the additive being selected from the group consisting of: an hydrate salt, and an hygroscopic chemical;
adding the PVDF to the solution to form the precursor solution;
coating the precursor solution on a substrate to form an as-deposited PVDF film;
drying and crystallizing the as-deposited PVDF film at an elevated temperature;
and
annealing the dried and crystallized PVDF film at a further elevated temperature, the further elevated temperature being greater than the elevated temperature but less than a melting point of the as-deposited PVDF film, the additive dehydrating at the further elevated temperature.

2. A method as claimed in claim 1, wherein the PVDF film is a dense ferroelectric β-phase PVDF polymer thin film.

3. A method as claimed in claim 1, wherein the elevated temperature is in the range 60° C. to 110° C. and the further elevated temperature is in the range 110° C. to 170° C.

4. A method as claimed in any one of claim 1, wherein the additive is dissolved in the solvent before the PVDF is introduced to form the precursor solution, the solvent being a mixture of dimethylformamide (“DMF”) and acetone.

5. A method as claimed in claim 1, wherein there is substantially no dehydration of the additive at the elevated temperature.

6. A method as claimed in claim 1, wherein the dehydration of the additive at the further elevated temperature comprises the decomposition of the additive.

7. A method as claimed in claim 6, wherein the decomposition of the additive comprises converting the additive to another chemical, the other chemical no longer being an hydrate salt or an hygroscopic chemical and being substantially unable to unite with or absorb water.

8. A method as claimed in claim 1, wherein the hydrate salt is at least one selected from the group consisting of aluminum nitrate nonahydrate at a concentration in the range 1 to 20% by weight, aluminum chloride hexahydrate at a concentration in the range 8 to 20% by weight, and chromium nitrate nonahydrate at a concentration in the range 4 to 20% by weight; the weight percentage being the amount of the additive to the amount of PVDF expressed as a percentage.

9. A method as claimed in claim 1, wherein the hygroscopic chemical is at least one selected from the group consisting of: ammonium acetate at a concentration in the range 4 to 40% by weight, 4-amino-2-hydroxybenzoic acid at a concentration in the range 8 to 40% by weight, and 1,3-acetonedicarboxylic acid at a concentration in the range 8 to 40% by weight; the weight percentage being the amount of the additive to the amount of PVDF expressed as a percentage.

10. A method as claimed in claim 1, wherein a layer of a conductive metal is coated on the substrate and the as-deposited PVDF film is coated on the layer of conductive metal.

11. A method as claimed in claim 10 further comprising heating the substrate prior to the coating to form an oxide layer on the substrate, the layer of the conductive metal being coated on the oxide layer and forming a bottom electrode for the PVDF film.

12. A substrate having coated thereon a dense ferroelectric β-phase PVDF polymer thin film comprising an additive being selected from the group consisting of: a hydrate salt, and a hygroscopic chemical; the dense ferroelectric β-phase PVDF polymer thin film being able to be dried and crystallized at an elevated temperature and annealed at a further elevated temperature, the further elevated temperature being greater than the elevated temperature but less than a melting point of the dense ferroelectric β-phase PVDF polymer thin film, the additive dehydrating at the further elevated temperature.

13. A substrate as claimed in claim 12, wherein the elevated temperature is in the range 60° C. to 110° C. and the further elevated temperature is in the range 110° C. to 170° C.

14. A substrate as claimed in claim 12, wherein there is substantially no dehydration of the additive at the elevated temperature, and the dehydration of the additive at the further elevated temperature comprises the decomposition of the additive.

15. A substrate as claimed in claim 14, wherein the decomposition of the additive comprises the additive being converted to another chemical, the other chemical being unable to unite with or absorb water.

16. A substrate as claimed in claim 12, wherein the hydrate salt is at least one selected from the group consisting of: aluminum nitrate nonahydrate at a concentration in the range 1 to 20% by weight, aluminum chloride hexahydrate at a concentration in the range 8 to 20% by weight, and chromium nitrate nonahydrate at a concentration in the range 4 to 20% by weight; the weight percentage being the amount of the additive to the amount of PVDF expressed as a percentage.

17. A substrate as claimed in claim 12, wherein the hygroscopic chemical is at least one selected from the group consisting of: ammonium acetate at a concentration in the range 4 to 40% by weight, 4-amino-2-hydroxybenzoic acid at a concentration in the range 8 to 40% by weight, and 1,3-acetonedicarboxylic acid at a concentration in the range 8 to 40% by weight; the weight percentage being the amount of the additive to the amount of PVDF expressed as a percentage.

18. A substrate as claimed in claim 12, wherein there is a layer of a conductive metal on the substrate and the dense ferroelectric β-phase PVDF polymer thin film is on the layer of the conductive metal, the layer of the conductive metal comprising a bottom electrode.

19. A substrate as claimed in claim 12 further comprising an oxide layer on the substrate and at least a pair of electrodes contacting the dense ferroelectric β-phase PVDF polymer thin film.

20. A poly(vinylidene fluoride) film on a substrate produced by the method of claim 1.

21. A substrate having coated thereon a dense ferroelectric β-phase PVDF polymer thin film as claimed in claim 12, when used in an electronic device selected from the group consisting of: a piezoelectric sensor, a piezoelectric transducer, a piezoelectric actuator, a ferroelectric Random Access Memory, and a dielectric film for capacitors.
